(19) United States
(12) Patent Application Publication
(10) Pub. No.: US 2003/0112985 A1
(43) Pub. Date: Jun. 19, 2003

(54) Electroacoustic converter for wide-band loudspeakers and headphones

(76) Inventors: Frank Baumgart, Magdeburg (DE); Thomas Khulisch, Berlin (DE)

Correspondence Address: COLLARD & ROE, P.C., 1077 Northern Boulevard, Roslyn, NY, 11576-1696, US

(21) Appl. No.: 10/300,484

(22) Filed: Nov. 20, 2002

(30) Foreign Application Priority Data
Nov. 20, 2001 (DE) 101 56 585.2

(51) Int. Cl. H04R 25/00; H04R 1/00; H04R 9/06; H04R 11/02

(52) U.S. Cl. 381/152; 381/398; 381/431

(57) ABSTRACT

The problem of providing an electroacoustic converter for wide-band loudspeakers or magnetless electrodynamic headphones for generating sound, in particular for application in the homogeneous and/or nonhomogeneous magnetic field of a magnetic resonance tomograph, an electroacoustic converter avoiding the drawbacks of the prior art, is essentially resolved in that the electroacoustic converter for generating sound comprises an elastically suspended oscillating body, whereby the oscillating body consists of a non-elastic or low-elastic, non-magnetic or only weakly magnetic material and is flatly and in a fixed manner connected with conductor paths, on which a Lorentz force is acting as the driving force when current is flowing. The Lorentz force is supplied by the magnetic field of the magnetic resonance tomograph.

### BACKGROUND

The invention relates to an electroacoustic converter for wide-band loudspeakers or electrodynamic headphones without magnets. This converter is for generating sound particularly for application in the homogeneous and/or nonhomogeneous magnetic field of a magnetic resonance tomograph.

The generation of sound with strictly defined properties and high quality, for example music, speech, and anti-sound, poses problems in magnetic resonance tomographs, also referred to as MRT-devices. Conventional sound converters are exposed to strong forces in their environment and additionally interfere with their application, which is based on a strong and completely uniform magnetic field. The problems posed by high sound emissions are discussed in a series of publications and patents (for an overview, see McJURY ET AL, Journal of Magnetic Resonance Imaging 12.37-45 [2000]). Effective sound converters are described that are compatible with magnetic resonance tomographs, wherein these sound converters are for generating useful sounds of all types, including anti-sound. Effective anti-sound requires close special proximity between the anti-sound generator and the zone that has to be actively calmed. The large-volume loudspeakers described in the patents DE 197 27 657 C1 and DE 100 18 032 C1, are installed within a magnetic resonance tomograph behind the head of a lying patient. It is possible to generate effective anti-sound of up to an upper frequency of about 500 Hz, and even of up to about 800 Hz under favorable conditions. Anti-sound between 500 and 800 Hz can be generated only with headphones or sound converters that can be installed not behind, but next to the head of the patient within the direct proximity of the ears of the patient.

The latest developments in the field of human magnetic resonance tomography such as gradient tubes which are optimized for tests of the central nervous system, or magnets with a very high field intensity (up to 8 Tesla), are indicative of the technology of the future. This means an increase in imaging methods with basic frequencies that are distinctly above 1 kHz.

According to the rule of the “tenth wavelength” in anti-sound technology, frequencies of up to about 1500 Hz can be erased if the anti-sound generator is positioned about 2 to 3 cm from the site or volume to be calmed. These short distances can be realized only with headphones. Headphones have already been successfully employed in the field of magnetic resonance imaging in combination with sound protection capsules serving as mechanical carriers of the sound converters. In this connection, the useful sound:

(1) can be transmitted into the sound protection capsules through an air conductance system with hoses;

(2) can be generated by piezo-ceramic converters (e.g. Panasonic Model Type WM-R30B and WM-R57B);

(3) can be generated by electrostatic sound converters (PALMER ET AL, MRC Institute of Hearing Research, University of Nottingham);

(4) can be generated by electrodynamic converters with a coil drive (BAUMGART ET AL: Med. Phys. 25(10) 1998, page 2068); or

(5) can be generated by those converters that operate based on the piston or displacement principle (DE 197 27 657 C1; DE 100 18 032 C1).

Headphones for application in a magnetic resonance tomograph are required to satisfy higher requirements overall with respect to ruggedness, safety, degree of efficiency and the size of their transmission range, than pure anti-sound loudspeakers. These pure anti-sound loudspeakers are mounted in a suitable location in the gradient tube. Thus, these headphones have to be very robust. They can not be mounted in any fixed manner, but are adjusted to each patient. Experience shows that they are not handled with special care in the daily routine. Cables or hose feed lines, the electrical connections, and the fastening of the sound converter within the capsule must be able to withstand shocks and vibrations. These headphones may neither break nor change their geometry or position.

The safety of the headphones is directly connected with the robustness and the functional principle of the sound converter. The greatest risk of burns is posed for the patient if electrical oscillating circuits develop within the headphones that have resonances in the range of the operating frequency of a magnetic resonance tomograph. Depending on the intensity of the magnetic field, this frequency range ranges from about 30 MHz to about 300 MHz. The radio frequency transmitting systems of a magnetic resonance tomograph of the current design are capable of delivering an output of up to 20 kW. Also undesired oscillating circuits of a very low quality are sufficient to absorb destructive amounts of radio frequency energy.

Therefore, a sound converter has to satisfy the requirement of preventing the development of these oscillating circuits through constructional measures even in case of any damage.

The degree of efficiency of a sound converter has to be as high of possible so that an adequate level can be generated for anti-sound (in excess of 100 dB within the capsule). The electric energy that has to be supplied to the converter will be as low as possible to exclude any impairment of the imaging quality. Since the headphones are individually attached to each patient, the position and alignment of the sound converters within the magnetic field of the magnetic resonance tomograph changes slightly with each patient. This should have as little influence as possible on the degree of efficiency and the transmission property of the sound converter.

The transmission range of a headphone should be broad. The sound converter is used not only for generating anti-sound (frequency range from about 80 Hz up to 1500 Hz), but also for transmitting speech and music with the highest possible quality. Therefore, an upper limit frequency of at least 12 kHz must be required.

No sound converter that is compatible with magnetic resonance tomographs has been described that adequately satisfies all of these requirements.

Furthermore, the present invention is based on the finding that the high levels of interfering sound of magnetic resonance tomographs can be effectively reduced at favorable cost by active noise abatement measures if an anti-noise generator with an adequately high output can be installed in the gradient tube of the magnetic resonance tomograph with a small spacing from the ears of the patient (or the tested person).

The publications and patents of other developers have been taken into account in earlier patents. They discussed the advantages and drawbacks of loudspeakers that operate only in the nonhomogeneous part of the magnetic field (DE 197 27 657 C1); other systems for erasing sound waves (DE 195 28 888 A1); earlier developments of systems for suppressing interfering noise in control rooms (EP 0 655 730 A1); as well as electrodynamic loudspeakers without their own magnets, which employ ferromagnetic field in homogenizers (U.S. Pat. No. 00/5,450,499 A).

An acoustic converter operating based on the displacement principle for application in the homogeneous and/or nonhomogeneous magnetic fields of a magnetic resonance tomograph is described in the patents DE 100 18 032 C1; DE 100 18 033 C1; and PCT/EPO1/03720- WO 01/76320 A2. However, the use of a sound converter operating as a headphone based on the displacement principle entails a number of drawbacks that may entirely prevent the use of these converters in headphones under certain circumstances.

The converter described in these documents works with the optimal degree of efficiency if the current-conducting lines extend perpendicular to the direction of the main magnetic field. The Lorentz forces caused by the flow of current are maximal at the given current intensity. However, it is not possible to realize this arrangement in headphones. The converter works in headphones with current-conducting lines predominantly extending in the direction of the main magnetic field and thus with a very poor degree of efficiency. However, the very strong magnetic field and the high degree of efficiency of the principle of the converter lead to an adequately high degree of sound radiation. The serious drawback of this arrangement, however, is the extreme dependence on the alignment in the magnetic field. Since the converter, when aligned parallel with the magnetic field, works with the theoretically poorest degree of efficiency, even a very minor deflection against the direction of the magnetic field suffices for distinctly increasing the degree of efficiency. Therefore, the properties of the converter change each time the headphones are attached, and have to be recalibrated for the application of anti-sound.

Another safety risk emerges when these converters which are formed from the self-inductivity of the wire coil are meander shaped. This converter, jointly with the cable capacity of the electrical feed lines, represents a system that is capable of electrical oscillation and of absorbing the electromagnetic waves in the working range of a magnetic resonance tomograph.

Accordingly, the purpose of the present invention is to provide an electroacoustic converter for wide-band loudspeakers or magnetless electrodynamic headphones, in particular for application in the homogeneous and/or nonhomogeneous magnetic field of a magnetic resonance tomograph, that avoids the drawbacks of the prior art described above.

### SUMMARY

According to the invention, the electroacoustic converter comprises an elastically suspended oscillating body for the generation of sound. This oscillating body consists of a nonelastic or only low-elastic, non-magnetic or only weakly magnetic material, and is flatly and in a fixed manner, joined with conductor paths. When current is flowing, the conductor paths are acted upon by a Lorentz force that acts as the driving force. This Lorentz force is supplied by the magnetic field of the magnetic resonance tomograph.

According to an advantageous embodiment of the invention, the conductor paths are arranged and electrically connected so that the Lorentz forces are generated when current is flowing and acting on the oscillating body and have predominantly the same direction and orientation.

According to another embodiment of the invention, the conductor paths are arranged and electrically connected so that the main component of the sum of all of the Lorentz forces generated when the current is flowing, points in a direction perpendicular to the plane in which the oscillating body is oscillating.

Furthermore, the conductor paths are arranged and electrically connected so that the Lorentz forces generated when current is flowing lead to one or more torques acting on the oscillating body.

Furthermore, the conductor paths are arranged and electrically connected so that the sum of all Lorentz forces leads to a laminar driving force in a direction perpendicular to the plane in which the oscillating body is oscillating, as well as to torques acting on the oscillating body.

Finally, one or more loudspeakers, equipped with the electroacoustic converter are used to completely or partially line the inner surface of the magnet of the magnetic resonance tomograph.

The present invention allows sound with defined properties to be generated with a high quality and with a high degree of efficiency within the strong magnetic field of a magnetic resonance tomograph. In addition to music and speech, the process of the invention also comprises the generation of sound for active noise abatement, in a manner that cannot be achieved with hose conductor systems, and only conditionally with other electrodynamic loudspeakers. The present invention can be installed in any desired location within the magnetic resonance tomograph and thus can be optimally adapted to the given purpose of application. This aspect is important for the application as an anti-sound loudspeaker. The loudspeaker has a broad frequency band and in particular, sounds above a frequency of 1 kHz can be generated. When using an oscillating body with no, or only low flexibility, the applied laminar driving principle assures that the bending oscillations and distortions occurring in connection with a conventional, local drive will not occur.

A large surface area of the oscillating body permits the application of many suitably arranged, electrically conductive elements preferably in the form of flat wires. The conductive elements are preferably electrically switched in parallel resulting in a very low ohmic resistance for the active components of the arrangement. The operational safety and the useful life of the sound generator are substantially increased and prolonged. Furthermore, using wires allows the strong alternating magnetic fields generated in the imaging process of a magnetic resonance tomograph with a frequency of up to 1500 Hz to generate only very low eddy currents in the conducting elements. This prevents heating of the conducting elements and will not have any interfering influences exerted on the magnetic gradient fields of the magnetic resonance tomograph.

The strong magnetic fields (flow densities of up to 3 T) of a magnetic resonance tomograph, which are untypical of a loudspeaker, will supply a high driving force (Lorentz force) on the oscillating body, which is connected with said conducting elements in a fixed manner. This high driving force is supplied even at low audible frequency currents through the electrically conducting elements. This permits an effective sound radiation already at low current densities. The magnetic fields generated by these currents are correspondingly low and do not impair the homogeneity of the main field, so that they have no interfering influence on the imaging process.

The complete omission of ferromagnetic materials permits safe handling of an electroacoustic converter in the form of an anti-sound loudspeaker under all circumstances. Ferromagnetic components could otherwise be accelerated like bullets in the direction of the center of the permanent magnetic field. No safety measures of any type are required for controlling ferromagnetic forces in the proximity of or within magnetic resonance tomographs.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1a shows the active part of an electroacoustic converter in which one or more conductor paths are attached to an oscillating body;

FIG. 1b shows the arrangement represented in FIG. 1a with current flowing through the conductor paths;

FIG. 2a shows the active part of a second embodiment of an electroacoustic converter in which one or more conductor paths are attached to an oscillating body;

FIG. 2b shows the arrangement represented in FIG. 2a with current flowing through the conductor paths;

FIG. 3a shows the active part of a third embodiment of an electroacoustic converter with one or more conductor paths attached to an oscillating body;

FIG. 3b shows the arrangement represented in FIG. 3a with current flowing through the conductor paths;

FIG. 4a shows the active part of a fourth embodiment of an electroacoustic converter with conductor paths attached to an oscillating body;

FIG. 4b shows the arrangement represented in FIG. 4a with current flowing through the conductor paths;

FIG. 5a shows the active part of a fifth embodiment of an electroacoustic converter with conductor paths attached to an oscillating body; and

FIG. 5b shows the arrangement represented by FIG. 5a with current flowing through the conductor paths.

### DETAILED DESCRIPTION OF THE DRAWINGS

Exemplified embodiment “I”: Plate-shaped oscillating body 1 with parallel conductor paths 2a (vertical drive):

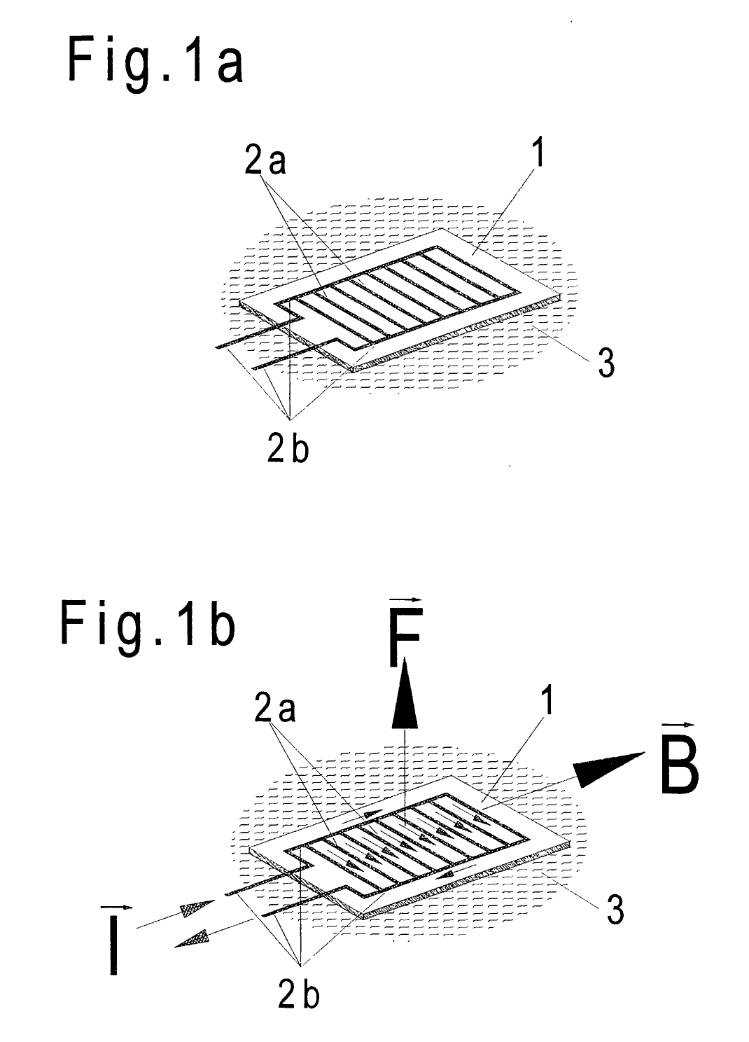

FIG. 1a shows the active part of a preferred embodiment of an electroacoustic converter (without a mounting system), in which oscillating body 1 consisting of a non-elastic or low-elastic, non-magnetic or only weakly magnetic material has the form of a plate. The oscillating body 1 is flatly connected with an elastic membrane 3 consisting of a non-magnetic or only weakly magnetic material.

One or more conductor paths 2a are attached to oscillating body 1 in an orthogonal or almost orthogonal manner in relation to an external static magnetic field B of a magnetic resonance tomograph that is not shown in detail but known per se, in a flat and fixed way so that a parallel or nearly parallel arrangement of conductor paths 2a is obtained. Conductor paths 2a so secured are electrically connected in parallel by electrical feed lines 2b, so that an electrical current I supplied through feed lines 2b flows through the conductor paths with the same orientation.

FIG. 1b shows the arrangement represented in FIG. 1a with current I flowing through conductor paths 2a. External magnetic field B of the magnetic resonance tomograph supplies a deflecting force acting on conductor paths 2a, its orientation being determined by the direction of current I flowing through the conductor paths. The effect of a conductor arrangement as described above is that the forces (Lorentz forces) acting on individual conductor paths 2a lead in the same sense to a resulting force that is directed perpendicular to the plane in which the presently plate-shaped oscillating body 1 is oscillating.

Current I with an audible frequency, i.e. an alternating current with a frequency between 20 Hz and 20 kHz, leads to movements of oscillating body 1 in the direction perpendicular to the plane in which the latter is oscillating. The pressure variations caused by these movements are radiated as sound waves on both sides perpendicular to the plate-shaped surface of the oscillating body 1. The degree of efficiency of this arrangement is optimal if magnetic field B of the magnetic resonance tomograph is oriented perpendicular to both the normal of the surface of the presently plate-shaped oscillating body 1 and the conductor paths 2a.

The present invention is directed to oscillating body 1. It is understood by the expert that the invention is accordingly not limited to a plate-shaped oscillating body 1 of the type described above in greater detail, but also covers any type of a suitable three-dimensional shape of oscillating body 1. For example, oscillating body 1 may also have a width-to-height-to-length ratio upwards or downwards deviating from a conventional plate-shaped form, and/or it may have curved outer contours, or even a curved basic design.

Any deviation from a plate-shaped geometry, for example in the form of curving or twisting of the entire arrangement or of parts thereof, may reduce the degree of efficiency without, however, putting the workability per se into question.

Likewise, the above embodiment and also the embodiments specified in the following are directed at conductor paths 2a that are arranged parallel or about parallel with each other (=preferred arrangement of the conductor paths 2a). However, the invention is not limited to a selected arrangement of conductor paths 2a, but also covers any arrangement deviating from a parallel arrangement of the conductor paths as long as Lorentz forces are generated that produce movements of oscillating body 1 that radiate sound waves.

Exemplified embodiment “II”: Plate-shaped oscillating body 1 with a greek- or serpentine-shaped arrangement of conductor paths 2a (torque drive):

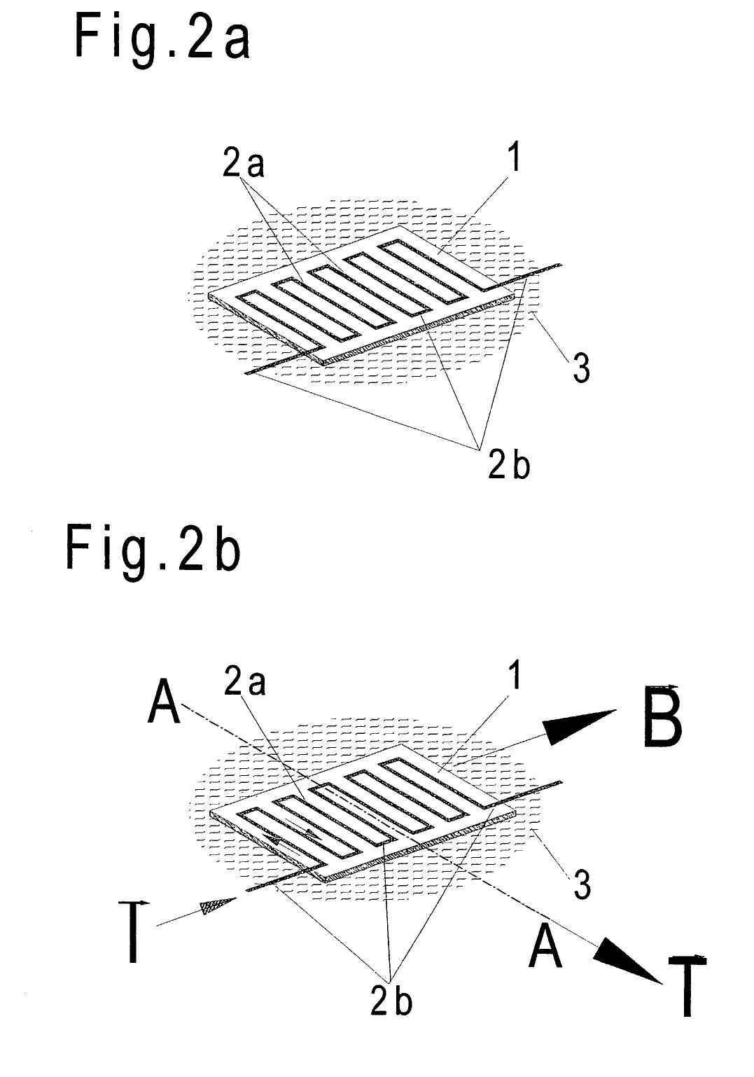

FIG. 2a shows the active part of a second possible embodiment of an electroacoustic converter (without the mounting), in connection with which oscillating body 1 consisting of a non-elastic or low-elastic, non-magnetic or only weakly magnetic material has the shape of a plate. Oscillating body 1 is flatly joined with elastic membrane 3 consisting of a non-magnetic or only weakly magnetic material.

One or more conductor paths 2a are attached to oscillating body 1 orthogonally or nearly orthogonally in relation to external static magnetic field B of the magnetic resonance tomograph, in a flat and fixed way so that a parallel or almost parallel arrangement of conductor paths 2a is obtained. Conductor paths 2a secured in this way are electrically connected with each other by electrical feed lines 2b so that electrical current I supplied via feed lines 2a flows through conductor paths 2a with an alternating oppositely directed orientation.

FIG. 2b shows the arrangement represented in FIG. 2a with current I flowing through the conductor paths 2a. External magnetic field B of the magnetic resonance tomograph supplies a deflecting force to conductor paths 2a, its orientation being determined by the direction in which current I is flowing through the conductor paths. The effect of a conductor arrangement of the type described above is that the forces (Lorentz forces) acting on the individual conductor paths 2a lead to a torque T that is directed perpendicular to the plane in which the presently plate-shaped oscillating body 1 is oscillating, and perpendicular to static magnetic field B.

Current I with an audible frequency leads to movements of oscillating body 1 around an axis of rotation A-A that is defined by torque T. The pressure variations caused by these movements are radiated as sound waves on both sides of the plate-shaped surface of oscillating body 1. The degree of efficiency of this arrangement is optimal if magnetic field B of the magnetic resonance tomograph is oriented perpendicular to both the normal of the surface of plate-shaped oscillating body 1 and to conductor paths 2a. A deviation from this geometry, may it be, for example in the form of curving or twisting of the entire arrangement or of parts thereof, may possibly reduce the degree of efficiency without, however, putting into question the workability.

Exemplified embodiment “III”: Plate-shaped oscillating body 1 with a combined parallel and loop-shaped arrangement of conductor paths 2a:

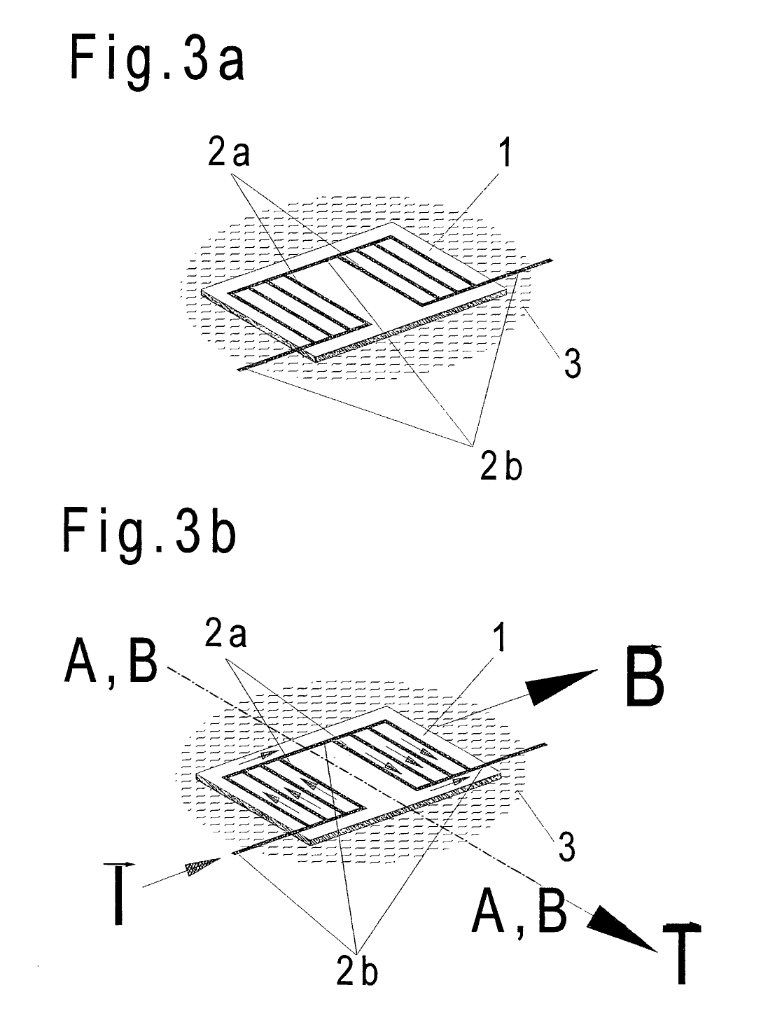

FIG. 3a shows the active part of a third possible embodiment of an electroacoustic converter (without the mounting) consisting of a non-elastic or low-elastic, nonmagnetic or only weakly magnetic material in the form of a plate. Oscillating body 1 is flatly joined with elastic membrane 3 consisting of a non-magnetic or only weakly magnetic material.

One or more of conductor paths 2a are attached to oscillating body 1 orthogonally or almost orthogonally in relation to external static magnetic field B of the magnetic resonance tomograph, in a flat and fixed way so that a parallel or almost parallel arrangement of conductor paths 2a is obtained. Conductor paths 2a secured in this manner are electrically connected with each other by electrical feed lines 2b so that electrical current I supplied via feed lines 2b flows through conductor paths 2a on opposite sides defined from each other by a reference axis B-B, with an oppositely directed orientation.

FIG. 3b shows the arrangement represented in FIG. 3a with current I flowing through conductor paths 2a. External magnetic field B of the magnetic resonance tomograph supplies a deflecting force acting on conductor paths 2a, its orientation being determined by the direction of current I flowing through the conductor paths. The effect of a conductor arrangement of the type described above is that the forces (Lorentz forces) acting on individual conductor paths 2a lead to torque T that is directed perpendicular to the plane in which the presently plate-shaped oscillating body 1 is oscillating, and perpendicular to static magnetic field B.

Current I with an audible frequency leads to movements of plate-shaped oscillating body 1 around axis of rotation A-A that is defined by torque T. The pressure variations caused by these movements are radiated as sound waves on both sides of the plate-shaped surface of oscillating body 1. If conductor paths 2a are arranged symmetrically with respect to axis B-B, axis B-B is identical with axis of rotation A-A. The degree of efficiency of this arrangement is optimal if magnetic field B of the magnetic resonance tomograph is oriented perpendicular to both the normal of the surface of plate-shaped oscillating body 1 and to conductor paths 2a. A deviation from this geometry in the form of any curving or twisting of the entire arrangement, or of parts thereof, may possibly reduce the degree of efficiency without, however, putting the workability into question.

Exemplified embodiment “IV”: Plate-shaped oscillating body 1 with parallel conductor paths 2a and additional resistors R (vertical drive):

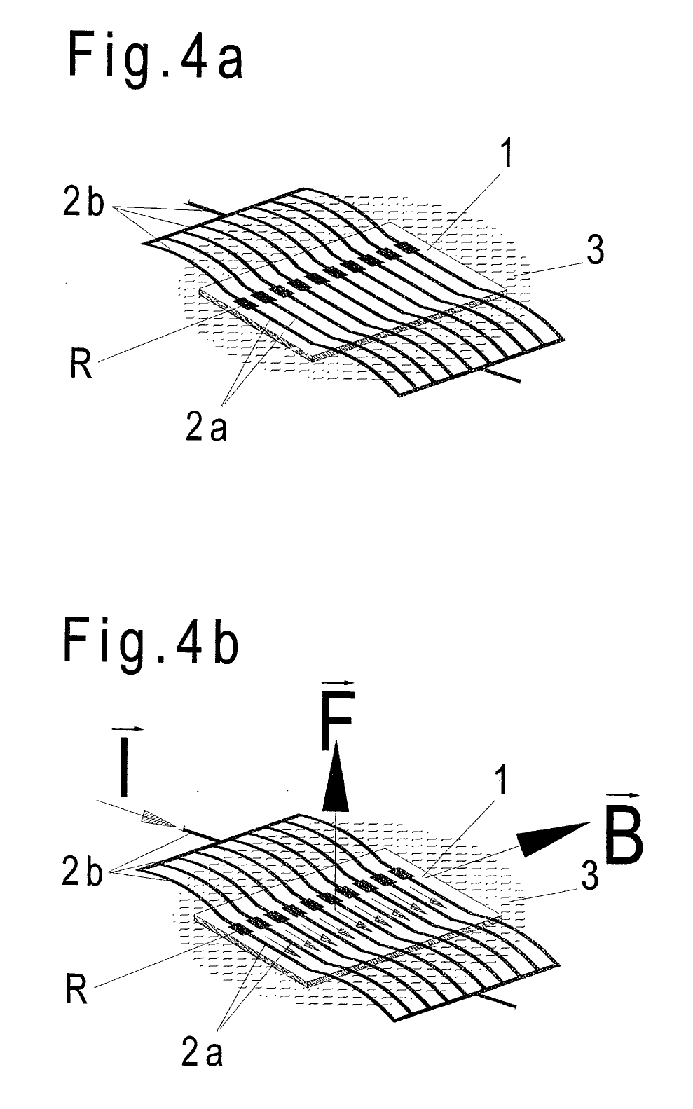

FIG. 4a shows the active part of a fourth possible embodiment of an electroacoustic converter (without the mounting), in connection with which oscillating body 1 consisting of a non-elastic or low-elastic, non-magnetic or only weakly magnetic material has the form of a plate. Oscillating body 1 is flatly joined with elastic membrane 3 consisting of a non-magnetic or only weakly magnetic material.

One or more of conductor paths 2a are attached to oscillating body 1 orthogonally or nearly orthogonally in relation to external static magnetic field B of the magnetic resonance tomograph, in a flat and fixed manner so that a parallel or nearly parallel arrangement of conductor paths 2a is obtained. Conductor paths 2a secured in this manner are electrically connected in parallel by electrical feed lines 2b, so that electrical current I supplied via feed lines 2b flows through conductor paths 2a with the same orientation. Each of the individual conductor paths 2a is connected in series with additional resistor R (for example by soldering, etching, etc.) that is dimensioned so that the total electrical resistance of conductor path 2a and additional resistor R is primarily determined by additional resistor R. By introducing two equally dimensioned additional resistors R for each conductor path 2a, the same or nearly the same intensity of the current passing through is obtained for each conductor path 2a.

FIG. 4b shows the arrangement represented in FIG. 4a with current I flowing through conductor paths 2a. External magnetic field B of the magnetic resonance tomograph supplies a deflecting force acting on conductor paths 2a, with its orientation being determined by the direction in which current I is flowing through. The effect of a conductor arrangement of the type described above is that the forces acting on individual conductor paths 2a lead in the same sense to a resulting force that is directed perpendicular to the plane in which the presently plate-shaped oscillating body 1 is oscillating.

Current I with an audible frequency leads to movements of plate-shaped oscillating body 1 in the direction perpendicular to the plane in which said body is oscillating. The pressure variations caused by these movements are radiated as sound waves on both sides vertically in relation to the plate-shaped surface of oscillating body 1. The degree of efficiency of this arrangement is optimal if magnetic field B of the magnetic resonance tomograph is oriented perpendicular to both the normal of the surface of plate-shaped oscillating body 1 and to conductor paths 2a. A deviation from this geometry, may it be, for example due to curving or twisting of the total arrangement of or parts thereof, may possibly reduce the degree of efficiency without, however, putting the workability into question.

Exemplified embodiment “V”: Plate-shaped oscillating body 1 with parallel conductor paths 2a and separate feed lines 2b and additional resistors R (vertical drive):

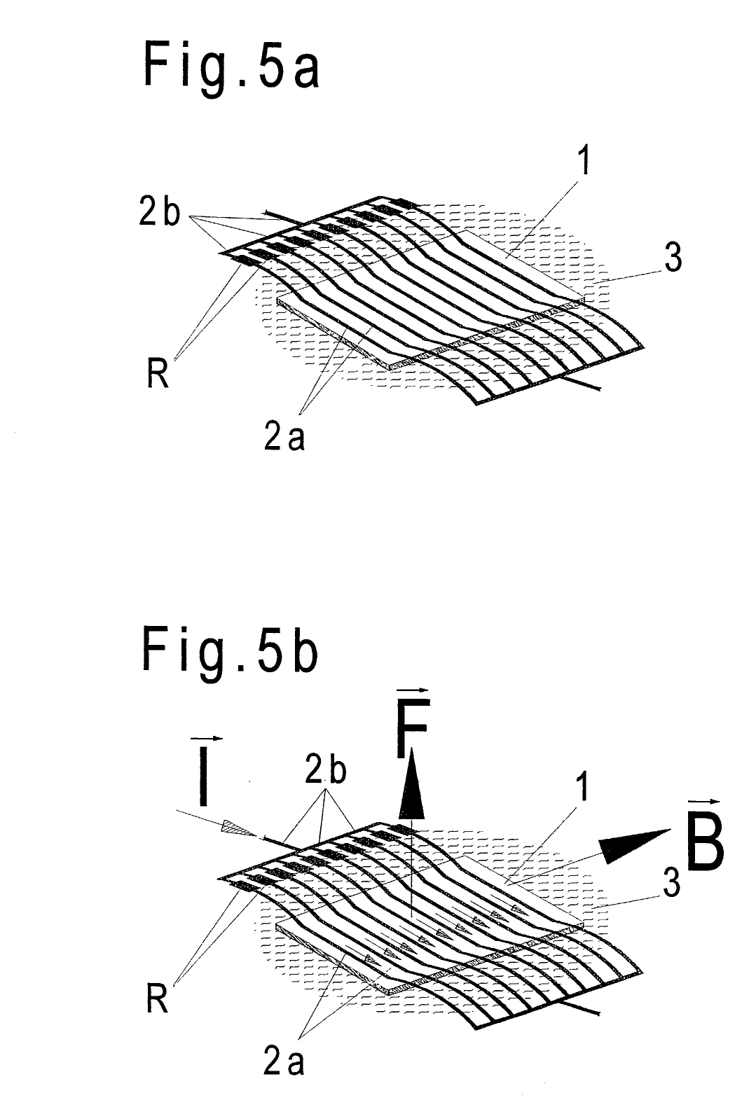

FIG. 5a shows the active part of a fifth possible embodiment of an electroacoustic converter (without the mounting), in connection with which oscillating body 1 consisting of a nonelastic or low-elastic, non-magnetic or only weakly magnetic material, has the form of a plate. Oscillating body 1 is flatly joined with elastic membrane 3 consisting of a non-magnetic or only weakly magnetic material.

One or more conductor paths 2a are attached to oscillating body 1 orhogonally or almost orthogonally in relation to external static magnetic field B of the magnetic resonance tomograph, in a flat and fixed manner so that a parallel or almost parallel arrangement of conductor paths 2a is obtained. Each conductor paths 2a secured in this manner is connected to separate feed lines 2b so that electrical current I supplied via all of feed lines 2b flows through conductor paths 2a with the same orientation. Each of individual electrical feed line 2b is connected in series with additional resistor R, which is dimensioned so that the total electrical resistance of feed line 2b, conductor path 2a and additional resistor R is primarily determined by additional resistor R. By introducing equally dimensioned additional resistors R for each feed line 2a, the same or nearly the same intensity of the current passing through is obtained for each conductor path 2a. The totality comprising electrical feed lines 2b and additional resistors R is attached in a flat and fixed manner on both sides of oscillating body 1 to elastic membrane 3, which prevents electrical feed lines 2b from moving due to the Lorentz forces occurring when current is flowing, and permits at the same time a free or only slightly limited movement of oscillating body 1.

FIG. 5b shows the arrangement represented in FIG. 5a with current I flowing through conductor paths 2a. External magnetic field B of the magnetic resonance tomograph supplies a deflecting force acting on conductor paths 2a, with its orientation being determined by the direction of current I flowing through. The effect of a conductor arrangement of the type described above is that the forces (Lorentz forces) acting on individual conductor paths 2a lead in the same sense to a resulting force that is directed perpendicular to the plane in which plate-shaped oscillating body 1 is oscillating.

Current I with an audible frequency leads to movements of oscillating body 1 in the direction perpendicular to the plane of oscillation. The pressure variations caused by these movements are radiated in the form of sound waves on both sides perpendicular to the plate-shaped surface of oscillating body 1. The degree of efficiency of this arrangement is optimal if magnetic field B of the magnetic resonance tomograph is oriented perpendicular to both the normal of the surface of the plate-shaped oscillating body 1 and conductor paths 2a. A deviation from this geometry, may it be, for example due to curving or twisting of the total arrangement or of parts thereof, may possibly reduce the degree of deficiency without, however, putting the workability into question.

Exemplified embodiment “VI”: Plate-shaped oscillating body 1 for one or more loudspeakers for the ring-shaped inside lining in the magnet of the magnetic resonance tomograph known per se (not shown in detail):

According to the invention, both the embodiments of a loudspeaker equipped with the electroacoustic converter as defined by the invention and described in the foregoing in greater detail, and all other conceivable embodiments of a loudspeaker that is based on the operating principle claimed herein, can be used for completely or partially lining the inside surface of the magnet of the magnetic resonance tomograph discussed herein.

Accordingly, while at least one embodiment of the present invention has been shown and described, it is to be understood that many changes and modifications may be made thereunto without departing from the spirit and scope of the invention as defined in the appended claims.

What is claimed is:

1. An electroacoustic converter for wide-band loudspeakers or wide-band headphones and for application in the homogeneous and/or nonhomogeneous magnetic field of a magnetic resonance tomograph, the electroacoustic converter comprising:
at least one elastically suspended oscillating body for generating sound and comprising an elastic or low elastic, substantially nonmagnetic or weakly magnetic material; and
a plurality of conductor paths flatly and fixedly connected to said material;
wherein the magnetic resonance tomograph supplies a Lorentz force that acts on said plurality of conductor paths when current is flowing through said plurality of conductor paths.

2. The electroacoustic converter according to claim 1, wherein said plurality of conductor paths are electrically connected and arranged so that when said current is flowing said Lorentz forces acting on said oscillating body have predominantly the same direction and orientation.

3. The electroacoustic converter according to claim 1, wherein said plurality of conductor paths are electrically connected and arranged so that when said current is flowing a main component of the sum of all said Lorentz forces generated, points in a direction perpendicular to a plane of oscillation of said oscillating body.

4. The electroacoustic converter according to claim 1, wherein said plurality of conductor paths are electrically connected and arranged so that when said current is flowing said Lorentz forces generated lead to one or more torques acting on said oscillating body.

5. The electroacoustic converter according to claim 1, wherein said plurality of conductor paths are electrically connected and arranged so that the sum of all said Lorentz forces leads to a laminar driving force in a direction perpendicular to a plane of oscillation of said oscillating body and to torques acting on said oscillating body.

6. The electroacoustic converter according to claim 1, wherein the electroacoustic converter is disposed in one or more loudspeakers, and wherein said loudspeakers completely or partially line the inside surface of the magnet of the magnetic resonance tomograph.

7. The electroacoustic converter according to claim 1, wherein said material has a flat surface.
